(19) United States
(12) Patent Application Publication
(10) Pub. No.: US 2026/0089422 A1
(43) Pub. Date: Mar. 26, 2026

(54) Eyeglasses with Built in Artificial Intelligence Hearing Augmentation

(71) Applicant: Altina Inc., New York, NY (US)

(72) Inventors: Tal Bar-Or, New York, NY (US); René Burmand Johannesson, DK-3060 Espergærde (DK); Mitchell E. Johnson, Stillwater, MN (US)

(21) Appl. No.: 19/327,705

(22) Filed: Sep. 12, 2025

Related U.S. Application Data
(60) Provisional application No. 63/699,077, filed on Sep. 25, 2024.

(51) Int. Cl. H04R 1/10; H04R 1/02; H04R 1/08

(52) U.S. Cl. CPC H04R 1/10; H04R 1/02; H04R 1/08

(57) ABSTRACT

Augmented eyeglasses integrate hearing-assistance hardware within the temples to deliver real-time, open-ear audio augmentation. A microphone array captures ambient sound and forwards the digital signals to an on-board processing chain that includes an edge AI processor executing speech-enhancement and noise-suppression models. Processed signals drive miniature, temple-mounted speakers that project directional sound toward the wearer’s ears without occluding the canal. One or more rechargeable lithium-ion battery is managed by a power-management integrated circuit and supplies regulated energy various elements. Communication systems support data exchange and firmware updates with external devices for personalization and performance improvement.

### CROSS-REFERENCE TO RELATED APPLICATIONS

The present application claims the benefit of and priority to U.S. Provisional Patent Application 63/699,077 filed September 25, 2024 and titled “Eyeglasses with Built in Artificial Intelligence Hearing Augmentation”, the contents of which is hereby incorporated by reference in its entirety for all purposes.

### BACKGROUND

### Field of Disclosure

This disclosure relates generally to augmented eyeglasses, and more specifically to eyeglasses including hardware for hearing augmentation.

### Description of the Related Art

Many individuals experience concurrent visual and auditory impairments that require simultaneous use of eyeglasses and hearing aids. Managing two independent devices imposes daily burdens that include separate storage, cleaning, and charging routines, which can be especially taxing for elderly users or those with limited dexterity. The physical coexistence of temple-mounted eyeglass arms and behind-the-ear hearing-aid housings often causes mechanical interference and discomfort, leading wearers to forgo one aid in favor of the other. These challenges highlight a longstanding need for technology that alleviates the logistical and ergonomic strain created by maintaining distinct optical and auditory assistive devices.

Prior industry efforts to merge hearing assistance with eyewear have produced bulky, power-hungry, and aesthetically unappealing products that compromise sound fidelity and wearer comfort. Early designs routed wired hearing-aid transducers through the frame, but critics cited poor acoustic performance and an awkward form factor that discouraged adoption. Even stand-alone hearing aids exhibit shortcomings: small in-ear or behind-the-ear models typically house only a limited microphone array and modest processing resources, constraining their ability to separate speech from complex background noise. Collectively, these limitations underscore the inadequacy of existing solutions and reinforce the demand for a more capable, user-friendly approach to combined vision and hearing assistance.

### BRIEF DESCRIPTION OF DRAWINGS

FIG. 1 illustrates an operating environment for a pair of augmented eyeglasses, according to an example embodiment.

FIG. 2 provides an example of augmented eyeglasses providing assistive audio signals to a user in an operating environment, according to an example embodiment.

FIG. 3A shows a box diagram of augmented eyeglasses, according to an example embodiment.

FIG. 3B illustrates an associated device, according to an example embodiment.

FIG. 3C illustrates a network system, according to an example embodiment.

FIG. 4 shows a box diagram of temple hardware for a pair of augmented eyeglasses, according to an example embodiment.

FIG. 5 illustrates temple hardware, according to an example embodiment.

FIG. 6A is a block diagram illustrating components of an example machine for reading and executing instructions from a machine-readable medium.

FIG. 6B shows an example workflow of processing information to generate assistive audio using the augmented eyeglasses, according to an example embodiment

FIG. 7 shows a pair of augmented eyeglasses having magnetic charging element, according to an example embodiment.

FIG. 8 illustrates augmented eyeglasses having laminated materials, according to an example embodiment.

FIG. 9 illustrates and example of a monopole speaker design for a pair of augmented eyeglasses, according to an example embodiment.

FIG. 10 is a block diagram illustrating components of an example machine for reading and executing instructions from a machine-readable medium, according to an example embodiment..

The figures depict various embodiments for purposes of illustration only. One skilled in the art will readily recognize from the following discussion that alternative embodiments of the structures and methods illustrated herein may be employed without departing from the principles described herein.

### SUMMARY

In some aspects, the techniques described herein relate to augmented eyeglasses including: a frame front including a pair of corrective lenses; and a first temple piece and a second temple piece, each temple piece connected to the frame front, and each temple piece structured to store temple hardware, the temple hardware including: an audio system including: at least one microphone configured to capture environmental sound and convert the environmental sound into received audio signals; an amplifier; and a speaker positioned within the temple piece and oriented to project sound towards an ear canal of a wearer based on input audio signals; a processing system including: a microcontroller configured to input the received audio signals from the at least one microphone and to apply one or more pre-processing functions to the received audio signals; and an edge processor configured to apply at least one artificial-intelligence model to the pre-processed received audio signals and generate assistive audio signals; and a non-transitory computer-readable storage medium including instructions that, when executed cause the processing system, cause the processing system to: receive, at the microcontroller and from the at least one microphone, received audio signals representing an environment surrounding the augmented eyeglasses; apply, with the microcontroller, one or more pre-processing functions to the received audio signals; applying, using the edge processor, at least one artificial intelligence model to the pre-processed, received audio signals to identify a sound modification based on a sound profile and generate assistive audio signals that include the sound modification; amplify, using the amplifier, the assistive audio signals; and generate, using the speaker, sound waves for assistive audio for the wearer based on the assistive audio.

In some aspects, the techniques described herein relate to an augmented eyeglasses, wherein the speaker includes a speaker exit that projects sound waves directed towards the wearer from an inner surface of the temple piece.

In some aspects, the techniques described herein relate to an augmented eyeglasses, wherein the speaker is a monopole speaker that projects sound waves that reflect off the wearer to mimic a dipole speaker.

In some aspects, the techniques described herein relate to an augmented eyeglasses, wherein: identifying the sound modification includes identifying a sound for augmentation, and generating the assistive audio signals augments the sound.

In some aspects, the techniques described herein relate to an augmented eyeglasses, wherein: identifying the sound modification includes identifying a sound for reduction, and generating the assistive audio signals reduces the sound.

In some aspects, the techniques described herein relate to an augmented eyeglasses, wherein the temple hardware includes: a communication system configured to communicate audio signals between the first temple piece and the second temple piece; wherein applying the at least one pre-processing function to the received audio signals includes receiving audio signals from temple hardware on an opposite temple and applying the pre-processing function leverages the received audio signals.

In some aspects, the techniques described herein relate to an augmented eyeglasses, wherein the temple hardware includes: a communication system configured to communicate information between the first temple piece and the second temple piece; wherein applying the at least one artificial intelligence model to the pre-processed, received audio signals includes receiving information from an opposite temple and applying the artificial intelligence leverages the received information.

In some aspects, the techniques described herein relate to an augmented eyeglasses, wherein the temple hardware includes: an accelerometer and gyroscope configured to measure acceleration information and determine a pose of a head of the wearer; and wherein applying the at least one artificial intelligence model to the pre-processed, received audio signals includes receiving acceleration information to generate assistive audio signals based on the determined pose.

In some aspects, the techniques described herein relate to an augmented eyeglasses, wherein the temple hardware includes: a force sensor configured to measure force information and determine a state change of the augmented eyeglasses; and wherein applying the at least one artificial intelligence model to the pre-processed, received audio signals includes receiving force information to modify audio processing.

In some aspects, the techniques described herein relate to an augmented eyeglasses, further including a charging port structured to resemble one or more rivets of a hinge.

In some aspects, the techniques described herein relate to a method for generating sound waves for assistive audio using augmented eyeglasses, the augmented eyeglasses including a frame front including a pair of corrective lenses and temple pieces connected to the frame front and structured to store temple hardware for generating assistive audio, the method including: receiving, at a microcontroller stored in the temple pieces from at least one microphone stored in the pieces, received audio signals representing an environment surrounding the augmented eyeglasses; applying, with the microcontroller, one or more pre-processing functions to the received audio signals; applying, using an edge processor stored in the temple pieces, at least one artificial intelligence model to the pre-processed, received audio signals to identify a sound modification based on a sound profile and generate assistive audio signals that include the sound modification; amplifying, using an amplifier stored in the temple pieces, the assistive audio signals; and generating, using a speaker stored in the temple pieces, sound waves for assistive audio for a wearer based on the assistive audio.

In some aspects, the techniques described herein relate to a method, wherein the speaker includes a speaker exit that projects sound waves directed towards the wearer from an inner surface of the temple pieces.

In some aspects, the techniques described herein relate to a method, wherein the speaker is a monopole speaker that projects sound waves that reflect off the wearer to mimic a dipole speaker.

In some aspects, the techniques described herein relate to a method, wherein identifying the sound modification includes identifying a sound for augmentation, and the method further includes: generating the assistive audio signals augments the sound.

In some aspects, the techniques described herein relate to a method, wherein identifying the sound modification includes identifying a sound for reduction, and the method further includes: generating the assistive audio signals reduces the sound.

In some aspects, the techniques described herein relate to a method, wherein the temple hardware includes a communication system configured to communicate audio signals between the temple pieces, and wherein applying the at least one pre-processing function to the received audio signals includes: receiving audio signals from temple hardware on an opposite temple and applying the pre-processing function leverages the received audio signals.

In some aspects, the techniques described herein relate to a method, wherein the temple hardware includes a communication system configured to communicate information between the temple pieces, and wherein applying the at least one artificial intelligence model to the pre-processed, received audio signals includes: receiving information from an opposite temple and applying the artificial intelligence leverages the received information.

In some aspects, the techniques described herein relate to a method, wherein the temple hardware includes an accelerometer and gyroscope configured to measure acceleration information and determine a pose of a head of the wearer, and wherein applying the at least one artificial intelligence model to the pre-processed, received audio signals includes: receiving acceleration information to generate assistive audio signals based on the determined pose.

In some aspects, the techniques described herein relate to a method, wherein the temple hardware includes a force sensor configured to measure force information and determine a state change of the augmented eyeglasses, and wherein applying the at least one artificial intelligence model to the pre-processed, received audio signals includes: receiving force information to modify audio processing.

In some aspects, the techniques described herein relate to a method, further including a charging port structured to resemble one or more rivets of a hinge.

### DETAILED DESCRIPTION

### I. Introduction

The systems and methods described herein bring together two sensory aids: a pair of eyeglasses and a hearing aid. The device integrates a hearing aid within a pair of eyeglasses, utilizing microphones and directional speakers for sound output. Embedded edge-AI chips process the auditory signals, enabling real-time speech-enhancement and noise-suppression adjustments in the sound quality tuned for the wearer’s auditory needs.

There has long been a need for a device that utilizes the systems and methods described herein. Visual and hearing impairments, often related to age, traumatic injury, or certain health conditions, commonly occur together, necessitating simultaneous use of eyeglasses and hearing aids. There is a significant subset of the population comprising the elderly, veterans, and individuals with certain medical conditions who require both aids concurrently. Beyond the logistical burden of maintaining two separate devices, many potential users avoid conventional hearing aids because of the social stigma attached to visibly worn earpieces. In fact, many people with mild-to-moderate hearing loss do not adopt hearing aids, partly due to the stigma associated with the devices. An integrated solution concealed in everyday eyewear therefore addresses both the maintenance challenge and the stigma barrier in a single form factor.

The market has witnessed several attempts to create combination products aiming to bridge the gap between glasses and hearing aids in a way that reduces the stigma associated with those devices. However, these solutions often fall short due to their bulkiness, inefficient power usage, and compromised sound fidelity in the pursuit of combined functionality. A prime example is a product that attempted to use the frames as a base for wired hearing aids, the glasses routing sound towards the wearer’s ears. These devices are largely criticized due to physical discomfort, poor sound quality, underwhelming aesthetics, and the fact that they remain recognizable as hearing aids which does not alleviate social stigma.

The inherent strength of the disclosed technology lies in its seamless and intelligent convergence of a hearing aid with a pair of eyeglasses, resulting in a coherent, comfortable, and efficient single device. By building the computational hardware directly into the eyeglass frames and employing directional speakers for discreet sound delivery, users perceive sound naturally while the edge-AI chips continuously separate speech from ambient noise, dynamically adjusting processing parameters in real time. The AI chips grant the glasses high-fidelity speech extraction, thereby solving both discomfort and inconvenience problems while also removing the visual cues that traditionally mark a user as a hearing-aid wearer. This combined approach addresses the multitude of issues that individuals who need both devices face, providing a streamlined, stigma-free, and effective solution.

### II. System Environment

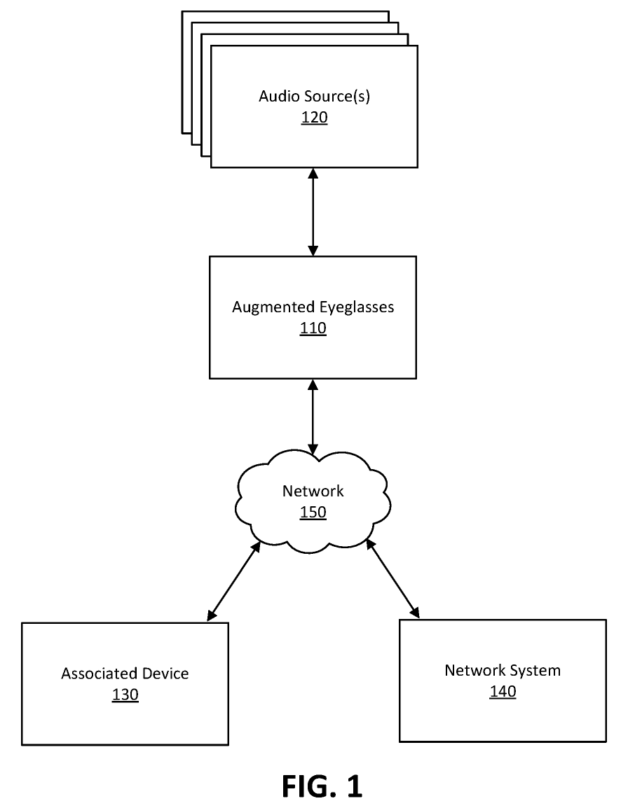

FIG. 1 illustrates an operating environment for a pair of augmented eyeglasses, according to an example embodiment. The operating environment 100 includes augmented eyeglasses 110, audio source(s) 120, an associated device 130, a network system 140, and a network 150. The operating environment 100 may include additional or fewer elements, or the elements may be arranged differently than what is described herein. For example, in some configurations, the augmented eyeglasses 110 may be configured to operate in the operating environment 100 without being connected to associated device 130 and/or network system 140.

The augmented eyeglasses 110, as described in detail hereinbelow, are configured for assisting a user wearing those augmented eyeglasses 110 to accurately sense the operating environment 100. For instance, the augmented eyeglasses 110 are configured to aid the user in viewing objects in the operating environment 100 (e.g., using corrective lenses), and hearing audio source(s) 120 in the operating environment 100 (e.g., using generated assistive audio). To aid in hearing, the augmented eyeglasses 110 may process received audio signals (e.g., from audio source(s) 120), and project assistive audio reflecting those received audio signals to the user. Generally, the assistive audio signals are processed and projected in a manner that renders the received audio signals more intelligible to the user.

Depending on the configuration, the augmented eyeglasses 110 may also be connected to an associated device 130 and/or a network system 140 via a network 150. The augmented eyeglasses 110 may leverage the associated device 130 and/or the network system 140 in various aspects of providing assistive audio signals to the user. For instance, the network system 140 may store unique parameters that the user employs for processing audio signals, the associated device 130 may perform some of the audio processing locally (rather than on the augmented eyeglasses 110), etc. Many different modalities of leveraging the connected processing capabilities of the associated device 130 and network system 140 are possible.

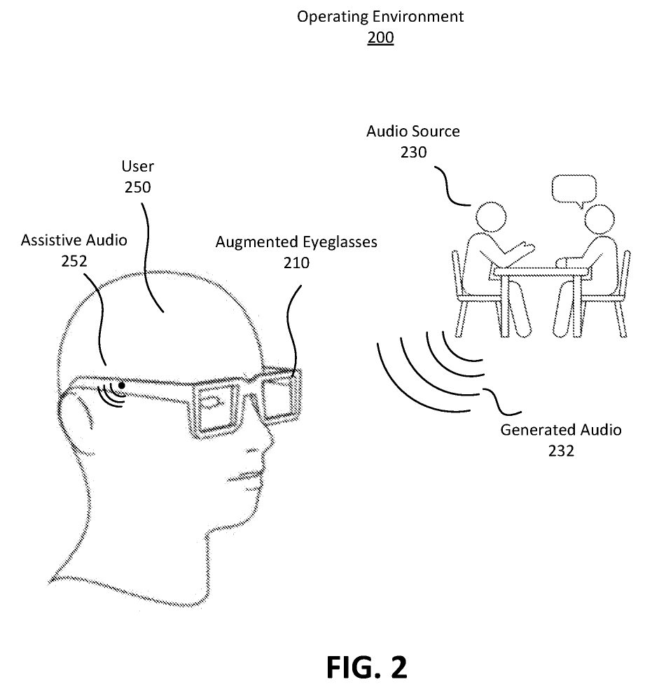

FIG. 2 provides an example of augmented eyeglasses providing assistive audio signals to a user in an operating environment, according to an example embodiment. In the example operating environment 200, an example pair of augmented eyeglasses 210 (e.g., augmented eyeglasses 110) are being worn by a user 250. The illustrated augmented eyeglasses 210 integrate the functionality of a pair of corrective lenses and a pair of hearing aids. The augmented eyeglasses 210 are worn by the user 250 and allow them to visualize things due to the corrective effects of the lenses in the eyeglasses and received assistive audio that augment the environment around them.

To expand, the operating environment 200 also includes an audio source 230. The audio source 230 is a couple at a table having a conversation. The couple is generating audio 232 (e.g., sound waves) and that audio is received by the augmented eyeglasses 210 (“received audio signals”). The augmented eyeglasses 210 processes the received audio signals to generate assistive audio signals. The assistive audio signals, when projected to the user 250, assist the user 250 in understanding the conversation (when they normally would be unable to do so, or would have a difficult time in doing so) as assistive audio 252. The augmented eyeglasses 210 also aid the user in viewing the couple at the table due to the corrective lenses.

### III Example Devices

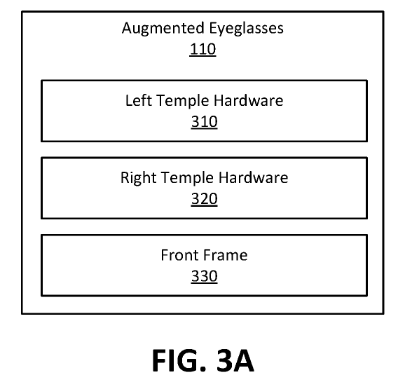

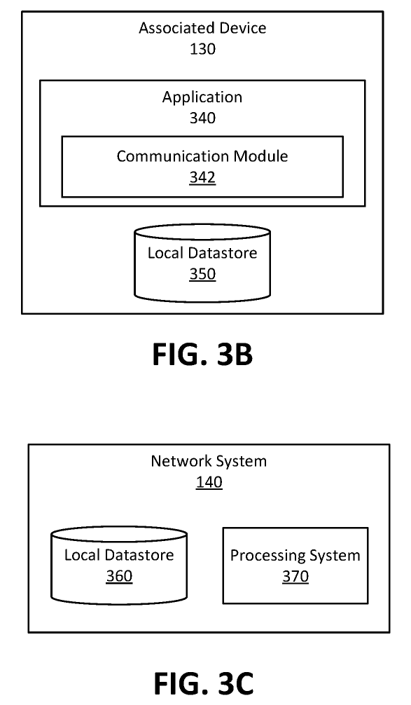

FIG. 3A shows a box diagram of augmented eyeglasses, according to an example embodiment. The augmented eyeglasses 110 includes left temple hardware 310, right temple hardware 320, and a frame front 330. The augmented eyeglasses 110 may include additional or fewer elements, or the elements may be arranged differently than what is described herein.

The left temple hardware 310 includes one or more hardware elements for generating assistive audio based on received audio signals. Similarly right temple hardware 320 includes one or more hardware and/or software elements for generating assistive audio based on received audio signals. Depending on the configuration, the hardware and/or software elements of each temple may be the same or different. For instance, in some configurations, only right temple hardware 320 may include a charging port, while both left temple hardware 310 and right temple hardware 320 may include speakers for projecting assistive audio. Temple hardware is described in more detail hereinbelow.

Additionally, the augmented eyeglasses 110 include a frame front 330. The frame front 330 house lenses or corrective lenses that aid in visualizing objects in the environment surrounding the augmented eyeglasses 110.

Notably, in an embodiment, none of the hardware is included in the frame fronts of the augmented eyeglasses. Additionally, in some embodiments, various elements of the augmented eyeglasses 110 are structured to hide one or more of the elements described herein. For instance, the charging port may be configured to resemble the rivets of a standard hinge, and the speakers may be embedded or partially embedded in, or obscured by, the temple pieces.

FIG. 3B illustrates an associated device, according to an example embodiment. The associated device 120 may be used to interact with the augmented eyeglasses 110 or a network system 140. In the illustrated example, the associated device 130 includes an application 340 (“app”) and a local datastore 350. In other embodiments, the associated device 130 includes different or additional elements. In addition, the functions may be distributed among the elements in a different manner than described.

The application 340 is software that executes on the associated device 130 to enable interaction with various functions of augmented eyeglasses 110. The application 340 may include a communications module 342. The communications module 342 sends and receives information to and from the network system 140 and/or augmented eyeglasses 110 over the network 150 and receives/processes information from the network system 140 and/or augmented eyeglasses 110 in response. The local datastore 350 includes one or more computer-readable media that store the data used by the associated device 130 and/or augmented eyeglasses 110. For example, the local datastore 350 may include user settings for the augmented eyeglasses 110. In some cases, associated device 130 may be used to further process audio signals or control processing of received audio signals.

In some cases, the associated device 130 is a traditional hearing aid including its own microphone, speakers, audio processing, etc. In this case, the augmented eyeglasses 110 may be leveraged by the hearing aid to generate audio signals that, when played back, generate assistive audio. In this situation, the augmented eyeglasses 110 may employ specific processing hardware to generate higher-quality assistive audio than the associated device 130 (e.g., an edge-processor executing a machine-learning algorithm.).

FIG. 3C illustrates a network system, according to an example embodiment. Network system 140 is a cloud-accessible system that communicates with the augmented eyeglasses 110 and/or associated device 130 over a network 150 to supply various information, functionality, resources, etc. At initialization, the augmented eyeglasses 110 may authenticate with the network system 140 and download wearer-specific parameters from a local datastore 360 (e.g., audiograms, gain maps, and preferred noise-suppression settings) that personalize the audio pipeline executed by the augmented eyeglasses 110. The network system 140 may also push firmware patches, software patches, model updates, etc. to the associated device 130 or augmented eyeglasses 110

In some cases, the network system 140 may execute computationally intensive tasks that are impractical on the low-power edge hardware present on augmented eyeglasses 110 on a local processing system 370. For instance, training new models and/or updating models may be performed by associated device 130 rather than augmented eyeglasses 110.

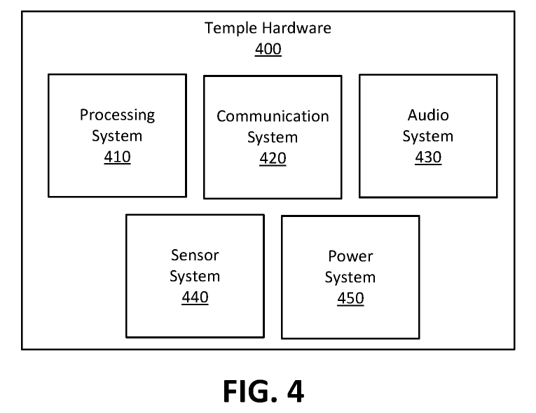

FIG. 4 shows a box diagram of temple hardware for a pair of augmented eyeglasses, according to an example embodiment. The temple hardware includes processing system 410, communication system 420, audio system 430, sensor system 440, and power system 450. The temple hardware 400 may include additional or fewer elements, or the elements may be arranged differently than what is described herein. Moreover, the temple hardware 400 may be representative of left temple hardware 310, right temple hardware 320, or both. Further, as described above, temple hardware 400 representing left temple hardware 310 may be the same or different than temple hardware 400 representing right temple hardware 320, depending on the configuration of augmented eyeglasses 110.

The augmented eyeglasses include a processing system 410. The processing system 410 includes one or more elements configured to execute machine-readable instructions that control sensor sampling, audio signal processing, communication protocol handling, etc. As an example, the processing system 410 may process received audio signals using on-board edge-compatible artificial intelligence algorithms (e.g., an embedded neural-network model) to generate assistive audio signals. The assistive audio signals, may be signals that, e.g., separate speech from background noise in real time when projected by the audio system 430 to a user.

The augmented eyeglasses include a communication system 420. The communication system 420 includes one or more systems configured for wireless data exchange between temples and/or with external devices (e.g., associated device 130, network system 140). As an example, the communication system 420 establishes a Bluetooth link to an associated device 120 such that firmware updates and user-specific hearing-profile parameters reach the processing system 410 without requiring a hard-wired connection. In another example, communication system 420 may communicate information from one temple to another temple such that assistive audio signals from left temple hardware 310 and right temple hardware 320 generate an accurate representation of the operating environment 100.

The augmented eyeglasses include an audio system 430. The audio system 430 includes one or more elements configured to generate directional sound fields that deliver assistive audio to the user’s ear canals based on assistive audio signals. As described below, audio system 430 generates assistive audio that reduces acoustic leakage. As an example, the audio system 430 drives miniature speakers embedded in each temple piece, producing a beam-formed output that aligns with the user’s ears based on head-pose data supplied by the sensor system 440.

The augmented eyeglasses include a sensor system 440. The sensor system 440 includes one or more elements configured to capture environmental and biomechanical signals that inform generating assistive audio signals for driving assistive audio. As an example, the sensor system 440 employs dual inertial-measurement units (or some other acceleration measurement unit) to track head orientation (or pose), enabling the processing system 410 to adjust gain and noise-suppression parameters dynamically based on head orientation. In some configurations, the sensor system may additionally include a gyroscope to aid in determining head orientation.

The augmented eyeglasses include a power system 450. The power system 450 includes one or more elements configured to store electrical energy and regulate its delivery to the other temple-hardware subsystems. As an example, the power system 450 combines a rechargeable lithium-polymer battery with a DC converter, allowing the communication system 420 to enter a low-power mode while still supplying sufficient current for the sensor system 440 to maintain pose tracking.

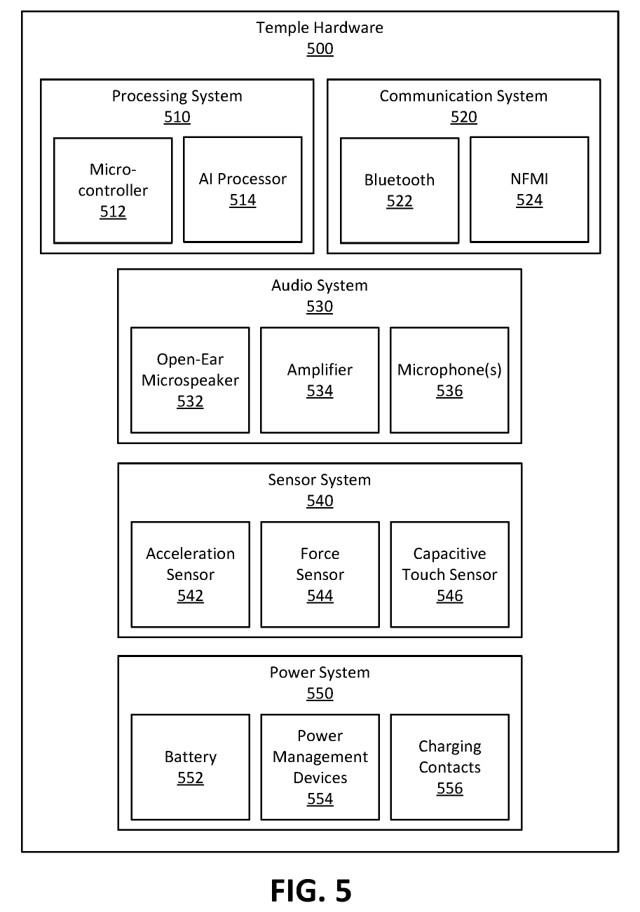

Many variations of the systems of the augmented eyeglasses 110 described in FIG. 4 are possible. For instance, FIG. 5 illustrates temple hardware, according to an example embodiment. The temple hardware 500 includes a processing system 510, a communication system 520, an audio system 530, and a sensor system 540. The processing system 510 includes a microcontroller 512 and an AI edge processor 514 (or edge processor, AI processor, etc.). The communication system 520 includes a Bluetooth system 522 and a near-field magnetic induction system 524. The audio system 530 includes one or more open-ear micro speakers 532, an amplifier, and one or more microphones 536. The sensor system 540 includes an acceleration sensor 542, a force sensor 544, and a capacitive touch sensor 546. The power system 550 includes a battery 552, power management devices 554, and charging contacts. In various configurations the temple hardware may include additional or fewer elements. Moreover, the functionality of various elements may be attributed to one or more different elements.

The temple hardware 500 includes a microcontroller 512 that receives digital signals representing audio (received audio signals) of the operating environment 100. In some examples, the microcontroller 512 may apply one or more pre-processing functions to the digital signals to prepare them for processing by the AI processor 514. The microcontroller 512 is communicatively coupled to the edge processor 514 and can transmit and receive information from the edge processor 514 (e.g., received audio signals, assistive audio signals).

The temple hardware 500 includes an AI processor 514. The AI processor 514 receives the digital signals representing audio of the user’s environment (received signals) and processes those signals in a manner that provides assistive audio to the user. For example, the AI processor 514 may amplify certain hearing frequencies, while dampening others. Importantly, because the AI processor 514 uses AI algorithms, the AI algorithms may identify specific sounds or voices (rather than frequency bands) for amplification or dampening. For instance, the AI processor 514 may execute an algorithm that identifies human speech (regardless of frequency) and generates signals that amplify that human speech and simultaneously identifies ambient noise and dampens that ambient noise. In either case, constructive or destructive techniques may be used. The AI processor 514 outputs digital signals representing sounds from the user’s environment that have been amplified or dampened to the microcontroller 512. Of course, what sounds the AI algorithm identifies for modification may be dependent on the user, their hearing profile, sensor system 540 inputs, etc.

Moreover, AI processor 514 is configured for executing AI algorithms “on-edge” rather than in the cloud. That is, the AI processor 514 includes components specifically designed to implement modern AI algorithms on-device in an efficient and power-efficient manner. In this instance, AI processor 514 is configured to process received audio signals to generate assistive audio signals corresponding to assistive audio. The AI processor 514 may implement one or more different models to accomplish this functionality. The models may be, e.g., a deep neural network.

More generally, the augmented eyeglasses include a processor. The processor allows for real-time processing using different types and complexities of algorithms. For example, in sound environments where standard, low requirement algorithms are needed, the processor may process sound signals received from the microphones for augmentation and projection via the speakers. In examples where the sound environments are challenging (e.g., restaurants), the processor may additionally (or alternatively) employ the AI Processor 514 to use advanced algorithms to process the sound for augmentation and projection via the speakers. Various conditions can be used to select between standard or advanced processing such as, e.g., user requests, input sound, output sound, sound characteristics, etc.

The temple hardware 500 may include a Bluetooth system 522 that facilitates short-range wireless connectivity with, e.g., associated device 130 and/or a network system 140. The Bluetooth system 522 supports data exchange, enabling firmware updates, synchronization of user profiles, and real-time transmission of sensor or audio data between the eyeglasses and connected devices. In some configurations, the Bluetooth transceiver also enables direct inter-temple communication, which enhances the integration and coordination of the device’s subsystems.

The temple hardware 500 may include a near-field magnetic induction (NFMI) transceiver 524 that provides a secure, low-power wireless channel for short-range communication between the temples and compatible external devices. The NFMI system 524 leverages magnetic coupling to exchange data reliably over very short distances which may reduce radio frequency interference and enhance the privacy of transmitted information. The near-field magnetic induction system 524 supports inter-temple synchronization for coordinated control of audio processing and sensor data, as well as facilitating connections with nearby hearing aids or accessories designed for NFMI operation.

Additional or alternative communication approaches are also possible. For instance, the communication system 520 may utilize Wi-R technology.

The temple hardware 500 includes a speaker 532 (or speakers). In a configuration, the speaker 532 is an open-ear micro speaker. The open-ear micro speaker is designed to reside within the temple of the augmented eyeglasses (and not within the user’s ear) without blocking the ear or ear canal. The open-ear speakers are configured to project sound into the user’s ears (e.g., using beamforming techniques). This design choice allows the wearer to receive amplified sound while still being aware of their surrounding auditory environment, effectively blending personal audio with ambient sounds. The micro speaker provides high-quality projected audio, amplifying and clarifying sounds processed by the AI Processor.

In a configuration, the speaker 532 of the augmented eyeglasses can be configured to have both a monopole acoustic design and dipole acoustic design. That is, the augmented eyeglasses can be togglable between monopole or dipole configurations, depending on the situation (e.g., user preference, environment characteristics, type of audio augmentation, etc.). To do so, one or more of the speakers may include a shutter. The shutter, when closed, prevents the speaker from emitting sound waves, and, when open, allows the speaker to emit sound waves. For instance, in some circumstances where a dipole acoustic design is preferential the shutter(s) can be toggled to open, and in circumstances where the monopole acoustic design is preferential the shutter(s) can be toggled to closed. More specifically, in situations where switching between a monopole and dipole design, a closed shutter will prevent sound waves from being emitted from one location on a temple, while an open shutter will allow sound waves from both locations on the temple.

In a configuration, the speaker 532 may include only a monopole speaker, and the speaker opening may face inwards towards the side of the user’s head. In this orientation, generated sound waves bounce off the user’s head and are reflected both upwards and downwards. The reflection of the sound waves can emulate a dipole design using a monopole configuration. A single monopole may induce more sound leakage than a dipole design, but algorithms executed by AI processor 514 may be configured to account for a solely monopole design. Structurally, the monopole configuration enables the augmented eyeglasses 110 to have a slimmer form factor and to preserve more low frequency sound output (because a lot of low frequency energy is lost in dipole designs).

The temple hardware 500 includes an amplifier 534 that amplifies assistive audio signals. The amplifier 534 boosts the audio signals generated by the augmented eyeglasses 110 before they are played back through the speaker 532. By increasing the amplitude of the audio signal, the amplifier 534 ensures that the sound produced is loud and clear enough for the wearer. The amplifier 534 assists in achieving high-resolution audio output by controlling and modulating amplitudes in various environments. Additionally, amplification solutions can conserve battery life by minimizing power requirements during times of lower audio demand.

The temple hardware 500 includes a microphone 536 (or microphones). The microphone captures sound inputs to the augmented eyeglasses 110. That is, the microphone 536 receives sound waves from the ambient environment and converts those sound waves into digital signals representing those sound waves. The microphone 536 may be a Micro-Electro-Mechanical System (MEMS) that enables sound measurements, or some other suitable microphone device. A microphone (e.g., MEMS microphone) generally allows for a highly sensitive and low power microphone in a very compact size that is easily integrable into the eyeglasses frame. The sound captured by the microphone 536 may be processed by the AI processor 514 to provide a tailored audio experience to the wearer via the open-ear speakers 532. In various embodiments, the augmented eyeglasses 110 may include, e.g., one, two, three, four, five, etc. microphones per temple.

In some cases, the microphone 536 may be used to supplement audio processing of a traditional hearing aid. For example, consider a person wearing a traditional hearing aid and the augmented eyeglasses 110 described above. The traditional hearing aid can be any form factor including but not limited to in the ear, in the canal, behind the ear, RIC, cochlear implant, etc. The traditional hearing aid has limited microphone 536 and audio processing capabilities. Moreover, in this example, in certain situations, the directional speakers of the augmented eyeglasses are less beneficial to the user than those in traditional in-ear hearing aids. In this case, the microphone 536 of the augmented eyeglasses 110 can be used to receive audio signals of the surrounding environment, the AI processor 514 can process those signals, and the augmented eyeglasses 110 can transmit those signals to the traditional hearing aid. The traditional hearing aid can then introduce the augmented audio to the wearer using traditional methods.

The temple hardware 500 may include an acceleration sensor 542, such as an accelerometer, capable of measuring movement and changes in orientation of the device. This sensor detects dynamic events (e.g., taps on the frame, removal or donning of the eyeglasses, and general head movements) and performs functions based on those detections. For instance, the acceleration data may be utilized by the augmented eyeglasses 110 to adapt audio output in real time, interpret user commands, or trigger specific device functions (e.g., as activating speech enhancement when a tap is detected).

The temple hardware 500 may include a force sensor 544 designed to detect, e.g., the magnitude of pressure or touch applied to specific regions of the frame. This sensor enables user interactions based on determining between different levels and durations of applied force (e.g., a quick tap versus a sustained press). The force sensor 544 can generate a range of control commands, allowing for gesture or interaction-based inputs to the augmented eyeglasses 110.

In some configurations, the temple hardware 500 includes a capacitive touch sensor 546. The capacitive touch sensor 546 may be integrated into the frame to enable user-friendly interaction with the augmented eyeglasses 110. The capacitive touch sensor 546 operates by detecting changes in electrical charge or capacitance when a user touches designated areas of the glasses, allowing the system to recognize and respond to specific gestures. This sensor can execute functions such as adjusting volume or switching operational modes. In turn, the capacitive touch sensor 546 generates control signals that are interpreted by the microcontroller 512 to modify sound processing parameters or trigger other augmented eyeglasses 110 functions.

Notably, one or more of the acceleration sensor 542, force sensor 544, and capacitive touch sensor 546 may be used to trigger functionality based on user interactions. For instance the acceleration sensor 542 or the force sensor 544 may be configured to interpret a series of taps to implement a certain functionality. Moreover, the temple hardware 500 may include control to adapt between detection schemes based on the user input (e.g., acceleration sensor functions better than a tap sensor for a first function, but vice versa for a second function), power availability, etc.

The temple hardware 500 includes a battery 552. The battery 552 may be, for example, a rechargeable lithium-ion battery or some other type of battery. The battery 552 provides electrical power to all integrated parts of the eyeglasses that comprise processors, sensors, audio output devices, etc. Typically, the battery 552 is compact and has a significant energy density, allowing for extended usage between recharges. Additionally, the battery 552 is configured for minimal self-discharge, and the battery 552 allows the eyeglasses to maintain power for a longer duration, alleviating the need for frequent recharging. Moreover, the battery 552 also offers excellent charge-discharge efficiency, translating into power consistency for the device's functionality. In some configurations, the battery 552 may be placed forward in the temples such that the portion of the temple enclosing the battery does not contact the user’s skin.

The temple hardware 500 includes a power-management integrated circuit (“PMIC”) 554. The PMIC 554 controls and manages the distribution of power from the battery to the various components of the augmented eyeglasses. The PMIC 554 enables efficient use of energy powering the system while optimizing battery life. By regulating the power supply to the different components based on their operational state and requirements, the PMIC 554 enables high quality performance without excess energy usage. The PMIC enables also provides safeguards against power-related issues such as overvoltage and under-voltage scenarios, thereby enabling longevity and stability of the device.

The temple hardware 500 includes charging contacts 556. In an example, the contacts 556 are low-profile magnetic charging contacts that reside on the temple. The contacts 556 may be structured to align automatically with a mating connector or dock to deliver power to the battery without exposed metal pins. In some cases, the magnets snap the plug into the correct orientation, creating a reliable electrical path that withstands casual handling and reduces wear compared to other types of charging schemes. In an example configuration, a charging case for the augmented eyeglasses 110 includes hinged flaps that pivot into place and mate with the temple contacts whenever the glasses are stowed, enabling hands-free overnight recharging and display-case power maintenance. Finally, the concealed or “hidden” placement of the contacts preserves the eyewear’s aesthetic and can mimic traditional hinge rivets to keep the electronics unobtrusive.

In some configurations, the microcontroller 512 is configured to manage information transfer between various elements of temple hardware 500. For example, the microcontroller 512may receive processed assistive audio signals and transmits them to the amplifier. Similarly, the microcontroller 512 may receive audio signals from the environment and transmit them to the AI processor 514. Still further microcontroller 512 may input one or more measurements from sensor system 540, process those inputs, transmit the inputs to the AI processor 514 alongside the received audio signals, and the AI processor 514 may processes the audio to generate assistive audio using the input measurements.

### IV. Example Information Processing

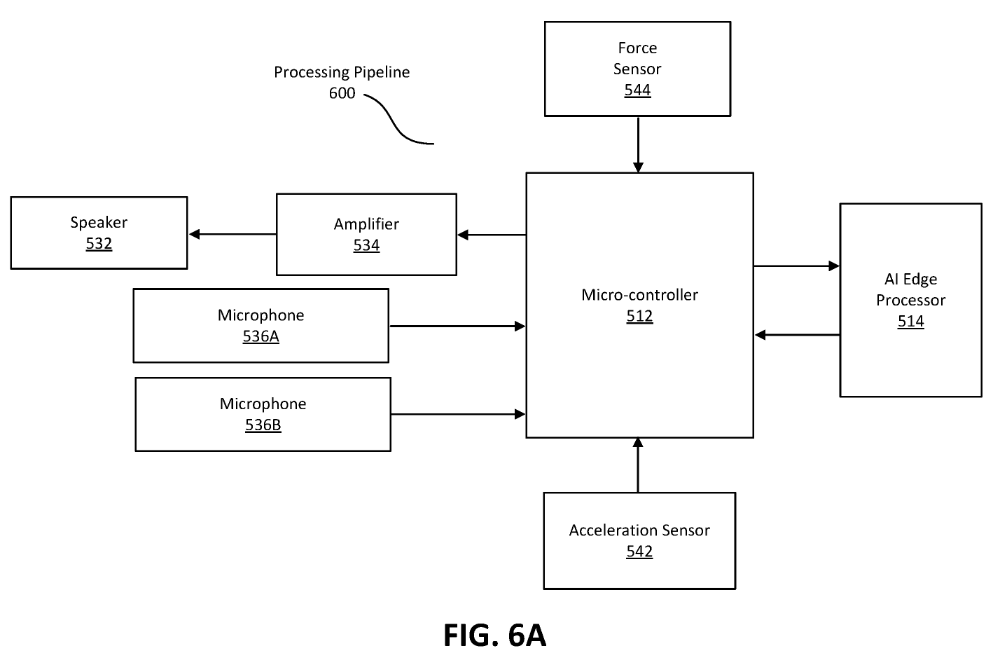

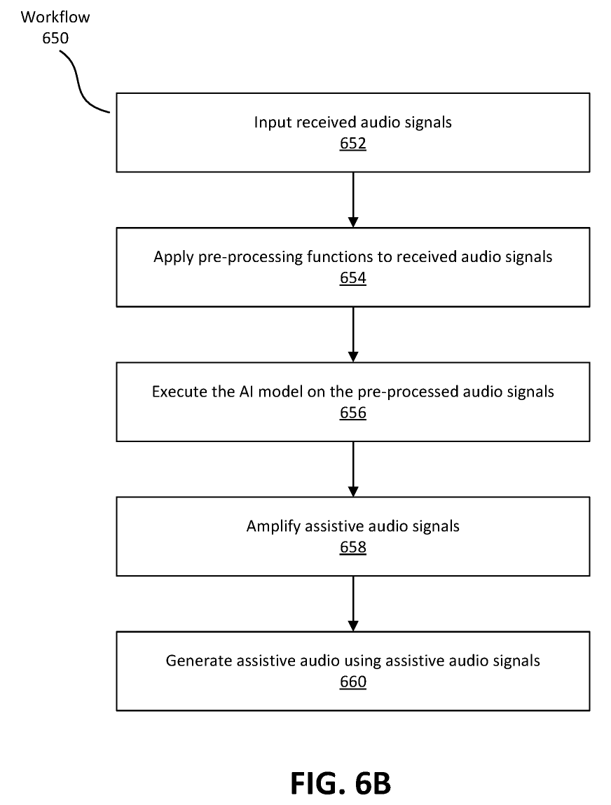

FIG. 6A illustrates a system diagram for components of the augmented eyeglasses, according to an example embodiment. The illustrated system diagram is used to describe an example data processing pipeline 600 for a pair of augmented eyeglasses (e.g., augmented eyeglasses 110).

One or more microphones (e.g., microphone 536A, 536B) sense sound waves representing sounds in the operating environment 100. The microphones 536 convert those sound waves into digital signals (“received signals”). The received signals representing the sound are transmitted to the microcontroller 512.

The microcontroller 512 receives the digital signals representing audio of the user’s environment (received signals). In some examples, the microcontroller 512 may apply one or more pre-processing functions to the digital signals to prepare them for processing by the AI processor 514. The microcontroller transmits 512 the digital signals to the AI processor 514.

The AI processor 514 receives the digital signals representing audio of the user’s environment and processes those signals in a manner that provides augmented hearing assistance to the user (e.g., generating assistive audio signals for assistive audio). For example, the AI processor 514 may amplify certain hearing frequencies, while dampening others. Importantly, because the AI processor 514 uses AI algorithms, the AI algorithms may identify specific sounds or voices (rather than frequency bands) for amplification or dampening. For instance, the AI processor 514 may execute an algorithm that identifies human speech (regardless of frequency) and generates signals that amplify that human speech and simultaneously identifies ambient noise and dampens that ambient noise. In either case, constructive or destructive techniques may be used. The AI processor 514 outputs digital signals representing sounds from the user’s environment that have been amplified or dampened to the microcontroller 512. Of course, what sounds the AI algorithm identifies for modification may be dependent on the user and their hearing profile and/or additional inputs from, e.g., sensor system 540.

The microcontroller 512 receives the processed signals and transmits them to the amplifier 534. The amplifier 534 receives the processed signals and amplifies them for projection to the user via the micro speaker. The degree and extent of amplification may be based on ambient noise levels or user preference. The amplifier 534 transmits the amplified signals to the speaker 532 and the speaker 532 generates sound waves based on the signals. The speaker generates and directs the sound waves (assistive audio) towards the user’s ear. The generated sound waves represent the amplified and/or dampened sound provided by the AI processor 514 configured to provide assistive audio.

In various embodiments, the capacitive touch sensor (not shown), force sensor 544, and/or acceleration sensor 542 may generate signals that control various aspects of the sound processing. For example, the sensors may generate a signal for increasing volume, stopping sound processing, etc.

As a specific example, the acceleration sensor 542 may be used to prevent amplification of the user’s voice. For instance, the accelerometer may generate signals that represent the user is speaking (e.g., signals representing jaw movement), and the augmented eyeglasses may determine that those signals represent that the user is speaking. When the user is speaking the processor may input that status and adjust the signal processing accordingly. For instance, the processor may dampen audio signals representing the user’s voice when the user is speaking. Further, the sensors may generate signals that can be determined to represent the user’s own voice and those signals can be removed or dampened when processed by the Processor (or processor).

FIG. 6B shows an example workflow of processing information to generate assistive audio using the augmented eyeglasses, according to an example embodiment. The workflow 650 may include additional or fewer steps, and the steps may be performed in a different order. Moreover, one or more of the steps may be repeated.

Augmented eyeglasses (e.g., augmented eyeglasses 110) include a conventional eyeglass frame front that holds a pair of corrective lenses. Hinged to the frame are first and second temple pieces. Each temple piece are constructed include and conceal a self-contained set of electronic subsystems without altering the external appearance of the eyewear. These subsystems (collectively “temple hardware”) include the audio, processing, communication, sensor, and power systems described throughout this disclosure

Within each temple, the audio subsystem includes at least one digital microphone that captures incident acoustic energy from the wearer’s surroundings and converts that energy into corresponding audio signals. Down-stream of the microphone, an amplifier provides variable-gain drive for a speaker positioned on the frames. The speakers drive acoustic output towards the wearer's ear canal.

The processing system pairs a low-power microcontroller with a higher-throughput edge processor. The microcontroller ingests the raw audio samples and performs front-end routines (e.g., automatic-gain control or spectral pre-emphasis) that condition the data for machine-learning inference. Pre-processed audio signals are passed to the edge processor, which executes at least one artificial-intelligence model trained to differentiate desirable content (e.g., speech) from background noise and to construct assistive audio signals that emphasize or attenuate specific sound elements as dictated by a user-specific profile.

A non-transitory computer-readable storage medium stores firmware that orchestrates this signal path. When executed, the code causes the processing system to (i) input 652 the microphone data at the microcontroller, (ii) apply 654 the pre-processing routines using the microcontroller, (iii) execute 656 the AI model on the pre-processed audio to return assistive audio signals, and (iv) causes 658 the amplifier to scale those assistive audio signals, and (5) cause the speaker generate 660 the assistive audio signals into sound waves perceptible as assistive audio for the wearer.

### V. Additional Configuration Considerations

As described above, the augmented eyeglasses (e.g., augmented eyeglasses 110) are formed to provide an aesthetic presence similar to a typical pair of eyeglasses. Accordingly, there are several technological implementations that enable a standard glasses aesthetic while providing augmented functionality.

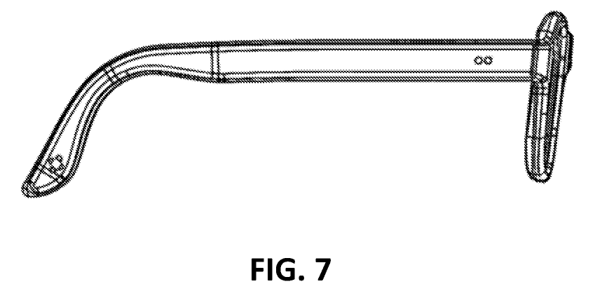

For example, the charging port may be configured to resemble rivets of a typical hinge of a pair of eyeglasses. To illustrate, FIG. 7 shows a pair of augmented eyeglasses having magnetic charging element, according to an example embodiment. In the illustrated example, the magnetic charging contacts may resemble the rivets of a hinge. The contacts of the charger may interface with a magnetic pogo-pin connector with spring-loaded pins.

For example, the frames and/or temples may be formed of materials that obscure or hide the embedded electrical components. For instance, the frames and/or temples may be made of layered acetate materials. In some cases, the acetate materials may be laminated together. In other examples, the material (e.g., acetate) may be opaque or may have a layer of paint added to an internal cavity. For instance, in an example configuration the material may be an using opaque black acetate material that can obscure the electronics, or may be an acetate layer having a layer of silver-colored reflective paint on the inside cavity.

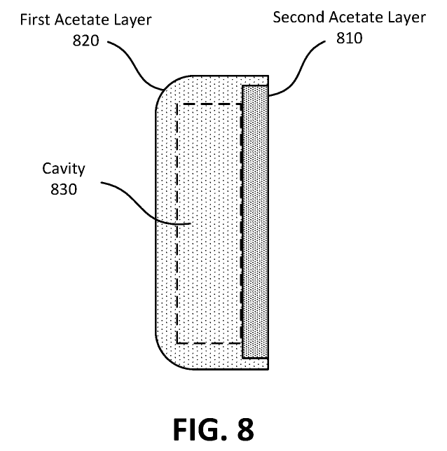

To illustrate, FIG. 8 illustrates augmented eyeglasses having joined materials, according to an example embodiment. For example, within the image, a first acetate layer 810 is joined to a second acetate layer 820. The second acetate layer 820 is milled such that when the two layers are joined, a cavity 830 for housing components of the augmented eyeglasses 100 is formed between the two layers. Components may be placed within the resulting cavity 830. The two acetate parts may be sealed using ultrasonic welding or other appropriate means such as bonding. In some configurations, a piece of aluminum may be affixed over the cavity. Depending on the configuration of the eyeglasses, the first layer may be opaque and the second layer may be transparent (or vice-versa). In some examples, both layers may be transparent, or both layers may be transparent. In some examples, the acetate may be laminated acetate or extruded acetate.

More broadly, the opaque and transparent layers can be configured for various types of design aesthetics. For example, the temples can be milled from a pre-laminated “transparent + opaque” acetate blank. This blank includes an opaque layer that is purpose-aligned with a future electronics cavity so batteries, PCBs, wiring, etc. disappear from sight, while the transparent layer is left at the crown or wearer-facing interior to give the frame a lighter, depth-rich appearance. Where a designer wishes to make the technology itself a visual feature, the strategy can be reversed. That is, the transparent layer is purposefully retained over selected sections of the cavity, allowing the circuitry to remain visible, with only small opaque islands shielding specific components. In turn, the same machining and bonding workflow supports either objective (e.g., using the opaque regions to hide electronics while preserving transparent areas for aesthetic effect, or selectively showcasing the electronics as an intentional design element).

For example, the augmented eyeglasses 110 may include a charging point configured such that they are functional with a charging case and/or display case. The charging case may include two small flaps that will magnetically align with the charging ports on the temples. The flaps are structured to accommodate different size eyewear. So, when a user places the eyeglasses in the case, the flaps fold into place and form a connection between the charging port and the charging case. The charging case then provides power to the batteries of the augmented eyeglasses. Similarly, the charging ports may be configured to interface with a display apparatus such that they can maintain their charge. The display apparatus may include discrete flaps that align with the magnetic charging ports of the temples when they are place on the apparatus for display. In some cases, the display apparatus may be constructed that enables the default positioning of the frames to allow charging on the display apparatus. In some cases, the flaps (or some other connection device) can reside inside the display apparatus, and attached to the frames by a person.

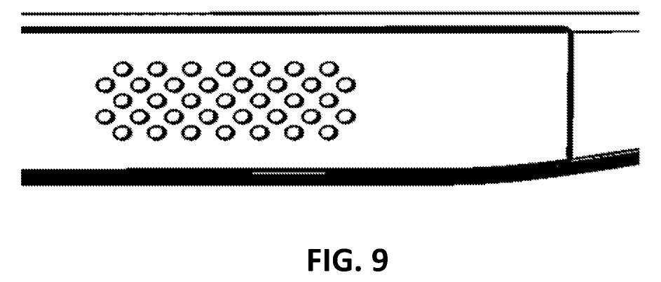

For example, the augmented eyeglasses 110 may include a single monopole speaker on each temple. The monopole speaker may be on an inner surface the frames with a speaker exit facing the user’s head rather than on a top or a bottom of the frames like in a dipole design. FIG. 9 illustrates and example of a monopole speaker design for a pair of augmented eyeglasses, according to an example embodiment.

For example, the augments eyeglasses 100 may include one or more power saving architectures. To expand, in some cases, the eyeglasses are never mechanically switched off. Instead, the power system holds the electronics in a quiescent “sleep” state that draws very low amounts of power hearing enhancement is not required. Because the device is already energized, waking to full processing readiness can occur quickly, allowing the wearer to invoke speech enhancement the moment a noisy environment is encountered. Additionally, eliminating a physical on/off switch also improves water-ingress resistance, removes a potential point of mechanical failure, and simplifies daily use for wearers with limited dexterity.

For example, a transition between the low-power sleep state and the active hearing-enhancement pipeline may be implemented through a double-tap gesture applied to either temple. To expand, the micro-controller continuously listens to sensor system 540 information for measurement representing two taps occurring within a preset temporal window (e.g., 300 ms). Upon recognizing the pattern the temple hardware 500 toggles the audio processing chain on or off, giving rise to the distinctive user experience of “double-tap your glasses to improve your hearing.”

For example, the temples may be fabricated from a custom, fully opaque tortoise-pattern acetate such that the internal cavity remains visually concealed. Unlike standard translucent tortoise sheets, this formulation blocks all light transmission, preventing the embedded electronics from being seen even at thinned wall sections formed during CNC milling. The pigmentation of the temples may be tuned so the opaque temple pieces visually match the conventional translucent tortoise acetate used on the frame front, yielding a uniform appearance across the eyewear regardless of local wall thickness or the presence of hardware beneath.

Notably, not all of the elements described herein need be applied to eyeglasses augmented with AI assisted hearing, but may be applied to more normal implementations of eyeglasses. For instance, the charging system described herein may be applied to other types of eyeglasses needing electrical charge (rather than solely for AI augmented glasses).

### VI. Example Computer System

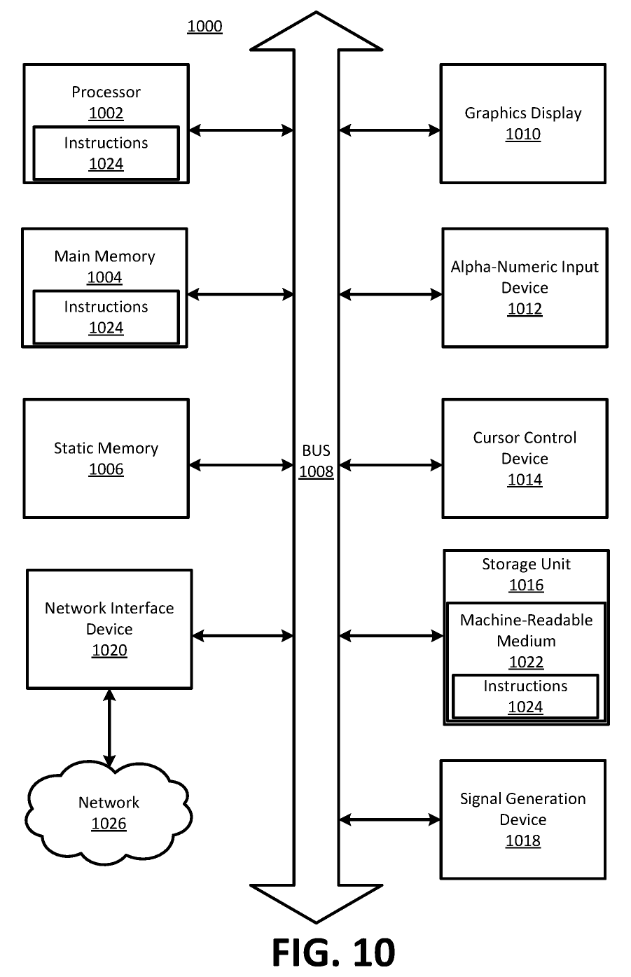

FIG. 10 is a block diagram illustrating components of an example machine for reading and executing instructions from a machine-readable medium, according to an example embodiment.. Specifically, the figures above show a diagrammatic representation of various computer systems in the example form of a computer system 1000. The computer system 1000 can be used to execute instructions 1024 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in an operating environment, or as a peer machine in a peer-to-peer (or distributed) environment.

The machine may be a server computer, a client computer, a personal computer (PC), a tablet PC, a set-top box (STB), a smartphone, an internet of things (IoT) appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes one or more processing units (generally processor 1002). The processor 1002 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 1000 also includes a main memory 1004. The computer system may include a storage unit 1016. The processor 1002, memory 1004, and the storage unit 1016 communicate via bus 1008.

In addition, the computer system 1000 can include a static memory 1006, a graphics display 1010 (e.g., to drive a plasma display panel (PDP), a liquid crystal display (LCD), or a projector). The computer system 1000 may also include alphanumeric input device 1012 (e.g., a keyboard), a cursor control device 1014 (e.g., a mouse, a trackball, a joystick, a motion sensor, or other pointing instrument), a signal generation device 1018 (e.g., a speaker), and a network interface device 1020, which also are configured to communicate via the bus 1008.

The storage unit 1016 includes a machine-readable medium 1022 on which is stored instructions 1024 (e.g., software) embodying any one or more of the methodologies or functions described herein. For example, the instructions 1024 may include the functionalities of modules of the system 130 described in FIG. 1. The instructions 1024 may also reside, completely or at least partially, within the main memory 1004 or within the processor 1002 (e.g., within a processor’s cache memory) during execution thereof by the computer system 1000, the main memory 1004 and the processor 1002 also constituting machine-readable media. The instructions 1024 may be transmitted or received over a network 1026 (e.g., network 150) via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store the instructions 1024. The term “machine-readable medium” shall also be taken to include any medium that is capable of storing instructions 1024 for execution by the machine and that cause the machine to perform any one or more of the methodologies disclosed herein. The term “machine-readable medium” includes, but not be limited to, data repositories in the form of solid-state memories, optical media, and magnetic media.

### VII Additional Considerations

In the description above, for purposes of explanation, numerous specific details are set forth in order to provide a thorough understanding of the illustrated system and its operations. It will be apparent, however, to one skilled in the art that the system may be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer-readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B is true (or present).

In addition, the use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for a system and a process for implementing the functionality described herein. Thus, while particular embodiments and applications have been illustrated and described, it is to be understood that the disclosed embodiments are not limited to the precise construction and components disclosed herein. Various modifications, changes, and variations, which will be apparent to those, skilled in the art, may be made in the arrangement, operation, and details of the method and apparatus disclosed herein without departing from the spirit and scope defined in the appended claims.

What is claimed is:

1. Augmented eyeglasses comprising:
a frame front comprising a pair of corrective lenses; and
a first temple piece and a second temple piece, each temple piece connected to the frame front, and each temple piece structured to store temple hardware, the temple hardware comprising:
an audio system comprising:
at least one microphone configured to capture environmental sound and convert the environmental sound into received audio signals;
an amplifier; and
a speaker positioned within the temple piece and oriented to project sound towards an ear canal of a wearer based on input audio signals;
a processing system comprising:
a microcontroller configured to input the received audio signals from the at least one microphone and to apply one or more pre-processing functions to the received audio signals; and
an edge processor configured to apply at least one artificial-intelligence model to the pre-processed received audio signals and generate assistive audio signals; and
a non-transitory computer-readable storage medium comprising instructions that, when executed cause the processing system, cause the processing system to:
receive, at the microcontroller and from the at least one microphone, received audio signals representing an environment surrounding the augmented eyeglasses;
apply, with the microcontroller, one or more pre-processing functions to the received audio signals;
applying, using the edge processor, at least one artificial intelligence model to the pre-processed, received audio signals to identify a sound modification based on a sound profile and generate assistive audio signals that include the sound modification;
amplify, using the amplifier, the assistive audio signals; and
generate, using the speaker, sound waves for assistive audio for the wearer based on the assistive audio.

2. The augmented eyeglasses of claim 1, wherein the speaker comprises a speaker exit that projects sound waves directed towards the wearer from an inner surface of the temple piece.

3. The augmented eyeglasses of claim 1, wherein the speaker is a monopole speaker that projects sound waves that reflect off the wearer to mimic a dipole speaker.

4. The augmented eyeglasses of claim 1, wherein:
identifying the sound modification comprises identifying a sound for augmentation, and
generating the assistive audio signals augments the sound.

5. The augmented eyeglasses of claim 1, wherein:
identifying the sound modification comprises identifying a sound for reduction, and
generating the assistive audio signals reduces the sound.

6. The augmented eyeglasses of claim 1, wherein the temple hardware comprises:
a communication system configured to communicate audio signals between the first temple piece and the second temple piece;
wherein applying the at least one pre-processing function to the received audio signals comprises receiving audio signals from temple hardware on an opposite temple and applying the pre-processing function leverages the received audio signals.

7. The augmented eyeglasses of claim 1, wherein the temple hardware comprises:
a communication system configured to communicate information between the first temple piece and the second temple piece;
wherein applying the at least one artificial intelligence model to the pre-processed, received audio signals comprises receiving information from an opposite temple and applying the artificial intelligence leverages the received information.

8. The augmented eyeglasses of claim 1, wherein the temple hardware comprises:
an accelerometer and gyroscope configured to measure acceleration information and determine a pose of a head of the wearer; and
wherein applying the at least one artificial intelligence model to the pre-processed, received audio signals comprises receiving acceleration information to generate assistive audio signals based on the determined pose.

9. The augmented eyeglasses of claim 1, wherein the temple hardware comprises:
a force sensor configured to measure force information and determine a state change of the augmented eyeglasses; and
wherein applying the at least one artificial intelligence model to the pre-processed, received audio signals comprises receiving force information to modify audio processing.

10. The augmented eyeglasses of claim 1, further comprising a charging port structured to resemble one or more rivets of a hinge.

11. A method for generating sound waves for assistive audio using augmented eyeglasses, the augmented eyeglasses comprising a frame front comprising a pair of corrective lenses and temple pieces connected to the frame front and structured to store temple hardware for generating assistive audio, the method comprising:
receiving, at a microcontroller stored in the temple pieces from at least one microphone stored in the pieces, received audio signals representing an environment surrounding the augmented eyeglasses;
applying, with the microcontroller, one or more pre-processing functions to the received audio signals;
applying, using an edge processor stored in the temple pieces, at least one artificial intelligence model to the pre-processed, received audio signals to identify a sound modification based on a sound profile and generate assistive audio signals that include the sound modification;
amplifying, using an amplifier stored in the temple pieces, the assistive audio signals; and
generating, using a speaker stored in the temple pieces, sound waves for assistive audio for a wearer based on the assistive audio.

12. The method of claim 11, wherein the speaker comprises a speaker exit that projects sound waves directed towards the wearer from an inner surface of the temple pieces.

13. The method of claim 11, wherein the speaker is a monopole speaker that projects sound waves that reflect off the wearer to mimic a dipole speaker.

14. The method of claim 11, wherein identifying the sound modification comprises identifying a sound for augmentation, and the method further comprises:
generating the assistive audio signals augments the sound.

15. The method of claim 11, wherein identifying the sound modification comprises identifying a sound for reduction, and the method further comprises:
generating the assistive audio signals reduces the sound.

16. The method of claim 11, wherein the temple hardware comprises a communication system configured to communicate audio signals between the temple pieces, and wherein applying the at least one pre-processing function to the received audio signals comprises:
receiving audio signals from temple hardware on an opposite temple and applying the pre-processing function leverages the received audio signals.

17. The method of claim 11, wherein the temple hardware comprises a communication system configured to communicate information between the temple pieces, and wherein applying the at least one artificial intelligence model to the pre-processed, received audio signals comprises:
receiving information from an opposite temple and applying the artificial intelligence leverages the received information.

18. The method of claim 11, wherein the temple hardware comprises an accelerometer and gyroscope configured to measure acceleration information and determine a pose of a head of the wearer, and wherein applying the at least one artificial intelligence model to the pre-processed, received audio signals comprises:
receiving acceleration information to generate assistive audio signals based on the determined pose.

19. The method of claim 11, wherein the temple hardware comprises a force sensor configured to measure force information and determine a state change of the augmented eyeglasses, and wherein applying the at least one artificial intelligence model to the pre-processed, received audio signals comprises:
receiving force information to modify audio processing.

20. The method of claim 11, further comprising a charging port structured to resemble one or more rivets of a hinge.
